(19) United States
(12) Patent Application Publication
(10) Pub. No.: US 2013/0112737 A1
(43) Pub. Date: May 9, 2013

(54) COMPOSITE POWDER FOR DIFFUSION-BRAZING ASSEMBLY OR RESURFACING OF SUPERALLOY PARTS

(71) Applicant: Jean-Francois Didier Clement, Yerres (FR)

(72) Inventor: Jean-Francois Didier Clement, Yerres (FR)

(73) Assignee: SNECMA, Paris (FR)

(21) Appl. No.: 13/810,950

(22) PCT Filed: Jul. 27, 2011
(86) PCT No.: PCT/FR2011/051811

§ 371 Date: Jan. 18, 2013

(30) Foreign Application Priority Data
Aug. 2, 2010 (FR) 1056393

(51) Int. Cl. B23K 35/24; B23K 20/00

(52) U.S. Cl. CPC B23K 35/24; B23K 20/00
USPC 228/119; 106/286.2; 228/194

(57) ABSTRACT

The invention relates to a composite metal powder for diffusion-brazing assembly or resurfacing of parts (1, 2) made of superalloy, the powder being formed by mixing a powder (3) of an Astroloy type base metal with a powder (4) of an NiCrB1055 type diffusion-brazing metal. The composite powder is free of silicon and it comprises in the range 65% to 70% by weight of Astroloy and in the range 30% to 35% by weight of NiCrB1055.

The present invention relates to a composite powder for diffusion-brazing assembly or resurfacing of superalloy parts.

Brazing is a method that usually consists in assembling together two metal parts, made of materials that may be identical or different, by means of a filler metal having a melting point that is well below the melting point of the materials of the parts. The filler metal is taken to the liquid state and the parts are heated by the filler metal but they remain solid.

In general terms, diffusion-brazing, also known as transient liquid phase bonding, is an operation for assembling together two metal parts that is analogous to brazing but in which the composition difference between the filler metal and the parts for assembling together is progressively resorbed by diffusion heat treatment. The heat treatment leads to a bond being formed that is chemically almost homogenous and that presents characteristics that are close to the characteristics of the parts for assembling together. Diffusion-brazing may thus be considered as being conventional brazing to which diffusion treatment has been added.

While two parts are being assembled together, use is made of a filler metal having a chemical composition that is close to that of the parts for assembling together, but that has a lower melting temperature. During diffusion-brazing, the filler metal melts and wets the surfaces of the parts that are to be assembled together, and then solidifies in isothermal manner by additive elements in the filler metal diffusing into the material of the parts, thereby changing their composition to become homogenous with the composition of the bead of brazing formed in this way. At the final stage of diffusion-brazing, the filler metal becomes integral with and indistinguishable from the material of the parts.

As mentioned above, such a method makes it possible to assemble together a plurality of parts, while giving the assembled-together parts and their connections mechanical and metallurgical characteristics that are comparable to the characteristics of the original parts. The temperatures used in such a method are also compatible with the superalloys that are conventionally used for making such parts, in particular in the field of aviation.

The use of diffusion-brazing is limited in particular by the clearance between the parts while they are being assembled together. If the clearance is too great, then the strength of the connection made by brazing is too weak to be able to satisfy the required specifications.

That has therefore led the Applicant to develop an improvement to the diffusion-brazing method for applications having larger clearances, of the order of a few millimeters. That method is the subject matter in particular of patent FR 2 511 908 in the name of the

Applicant, and is usable both for assembling parts together and for repairing cracks or for reconstructing zones that have become worn or damaged in operation, or indeed for modifying gas flow sections in turbine nozzles made of nickel-based superalloy.

That document describes in particular the use of a composite powder for diffusion-brazing assembly of superalloy turbojet vanes, the powder being made up of a mixture of a powder of a base metal of the Astroloy type or NK17CDAT with a powder of a diffusion-brazing metal comprising boron, or nickel, chromium and boron, or boron and silicon. An example given in that document states that the powder comprises in particular 75% by weight of Astroloy powder and 25% by weight of NiCrB1055 powder.

Astroloy (NK17CDAT) is a nickel-based superalloy that comprises by weight 16.9% cobalt, 14.8% chromium, 3.87% aluminum, 3.45% titanium, 5.1% molybdenum, and 0.015% carbon. NiCrB1055 is also a nickel-based superalloy and includes, by weight, 15% chromium and 4% boron.

The principles of the method of resurfacing by diffusion-brazing are similar to those of assembly by diffusion-brazing, with the special feature being that the filler metal is in the form of a composite powder formed by mixing a base metal powder of composition close to the composition of the part for repairing with a powder of a diffusion-brazing metal, also known as a “fondant”.

An object of the invention is to improve the properties of the composite powder known from document FR 2 511 908, in particular in terms of brazability and melting.

In addition, certain parts that operate in a highly oxidizing atmosphere and at high temperature, such as turbine parts, require specific treatment in order to limit the oxidation and corrosion that is caused by the combustion gas.

For that purpose, those parts that have also been repaired or assembled together by diffusion-brazing are themselves coated by thermochemical treatment that is performed in an atmosphere that is rich in aluminum.

During the surface treatment, effervescences or tubercules are created on the beads of brazing, which then need to be eliminated by expensive mechanical removal operations.

Another object of the invention is to provide a solution to this problem that is simple, effective, and inexpensive.

To this end, the invention provides a composite metal powder for diffusion-brazing assembly or resurfacing of parts made of superalloy, the powder being formed by mixing a powder of an Astroloy type base metal with a powder of an NiCrB1055 type diffusion-brazing metal, the powder being characterized in that it is free of silicon and in that it comprises in the range 65% to 70% by weight of Astroloy and in the range 30% to 35% by weight of NiCrB1055.

The use of a composite powder of the invention as a filler metal for resurfacing or assembling parts together does not give rise to effervescences or to tubercules during subsequent treatment performed in an aluminum-rich atmosphere.

Studies have shown that such effervescences or tubercules are avoided for the following reasons.

In the prior art, during the subsequent surface treatment, aluminum in vapor form diffuses into the brazing previously performed during resurfacing or assembly and it reacts with the silicon contained in the filler metal so as to form eutectic compounds of low melting point. In particular, the melting points of those compounds are lower than the temperature to which the parts are subjected during the surface treatment, so that those eutectic compounds melt, and on cooling they form the above-mentioned effervescences or tubercules.

During the treatment, the eutectic phases of the brazing are removed to such an extent that it is possible for a continuous array of pores to be formed, which leads to brazed joints being obtained that are not leaktight since they have open porosity, and also leads to degraded mechanical strength.

In particular, the melting point of one of those eutectics lies in the range 600° C. to 700° C. (eutectic at 660° C.), whereas the temperature to which the parts are subjected during the treatment is about 1150° C.

The use as a filler metal of a composite powder that does not have any silicon makes it possible to avoid forming those low melting point eutectic compounds and thus to avoid unwanted effervescences or tubercules.

In addition, the particular composition of the composite powder provides it with better melting, better brazability, and offers better mechanical characteristics after brazing.

The composition of the composite powder also makes it possible to fill all of the interstices between the grains during diffusion-brazing so as to end up with an alloy that is very dense.

Preferably, the composite powder comprises about 67.5% of Astroloy and about 32.5% by weight of NiCrB1055.

According to a characteristic of the invention, both the Astroloy powder and the NiCrB1055 powder present grain size lying in the range 60 micrometers (μm) to 70 μm, and preferably of the order of 63 μm.

This makes it possible to obtain a powder that is homogenous, dense, and with little porosity. The finer the powder, the smaller the spaces between the grains, and thus the greater the density of the alloy that is obtained after diffusion-brazing. Nevertheless, a fine powder also presents a specific surface area that is large, thereby increasing the risks of the powder being contaminated, which might lead to defects after diffusion-brazing.

A grain size of the order of 63 μm is the best compromise between good density and the appearance of defects in the resulting alloy.

The invention also provides the use of a composite powder of the above-specified type for diffusion-brazing assembly or resurfacing of superalloy parts.

Advantageously, the superalloy parts are nickel-based.

The composite powder may be heated to a temperature lying in the range 1180° C. to 1200° C. for a period lying in the range 5 minutes (min) to 30 min.

In preferred manner, the superalloy parts are elements of a turbine engine, e.g. nickel-based nozzle sectors for a low-pressure or high-pressure turbine, and they are protected by aluminization.

The invention can be better understood and other details, characteristics, and advantages of the invention appear on reading the following description made by way of non-limiting example and with reference to the accompanying drawing, in which:

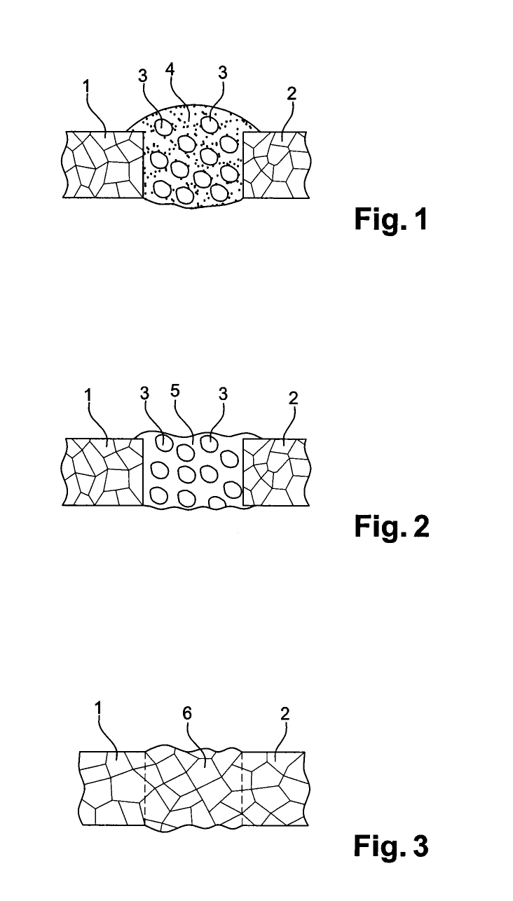

FIGS. 1 to 3 are diagrammatic views illustrating different successive physicochemical states of the brazing zone between two parts, as obtained with the help of a composite powder of the invention.

FIGS. 1 to 3 show two parts 1 and 2 of a turbojet assembled together by diffusion-brazing, e.g. a part 1 that is fitted on a nozzle sector 2 of a high-pressure or low-pressure turbine, the fitted-on part 1 being, by way of example: a cooling jacket, a plate for closing a circuit, or an air admission bushing. The parts 1 and 2 are made of nickel-based superalloy and they are assembled together with the help of a composite powder made up by mixing a powder 3 of an Astroloy type base metal with a powder 4 of an NiCrB1055 type diffusion-brazing metal. The composite powder is free of silicon and it comprises in the range 65% to 70% by weight of Astroloy and 30% to 35% by weight of NiCrB1055.

The composite powder preferably has about 67.5% by weight Astroloy and about 32.5% by weight NiCrB1055. Both the Astroloy powder and the NiCrB1055 powder present grain size lying in the range 60 μm to 70 μm, being preferably about 63 μm.

The surfaces of the parts 1 and 2 that are to be assembled together are prepared in such a manner as to remove the contaminated surface layer. This preparation is described in particular in document EP 0 974 418.

The composite powder is then deposited between two surface of the parts 1 and 2 that are to be assembled together, and it is then heated.

More particularly, diffusion-brazing may comprise a temperature rise over about 3 hours (h) to 1200° C., a first pause of 12 min at 1200° C., followed by a second pause of 2 h at 1150° C., and then a reduction in temperature from 1150° C. to 20° C. over about 2 h.

During the diffusion-brazing, the NiCrB1055 grains of the diffusion-brazing powder 4 melt first. The liquid phase 5 to which they give rise is held by capillarity and it wets the surfaces of the parts 1 and 2 and of the Astroloy grains of the base powder 3, as shown in FIG. 2.

After cooling, a solid intermediate layer 6 is formed between the two parts 1 and 2, which layer presents a metallographic structure that is homogenous and that is diffusion bonded to the surfaces of the parts 1 and 2 (FIG. 3).

1. A composite metal powder comprising:
65% to 70% by weight of an Astroloy powder,
30% to 35% by weight of an NiCrB1055 powder, and
no silicon.

2. The composite powder of claim 1, comprising about 67.5% by weight of the Astroloy powder and about 32.5% by weight of the NiCrB1055 powder.

3. The composite powder of claim 1, wherein both the Astroloy powder and the NiCrB1055 powder have a grain size in a range of 60 μm to 70 μm.

4. A method of diffusion-brazing assembly or resurfacing comprising contacting the composite powder of claim 1 with at least one superalloy part.

5. The method of claim 4, wherein the superalloy part comprises nickel.

6. The method of claim 4, further comprising heating the composite powder to a temperature in a range of 1180° C. to 1200° C. for a period in a range of 5 min to 30 min.

7. The method of claim 4, wherein the superalloy part is an element of a turbine engine.

8. The composite powder of claim 2, wherein both the Astroloy powder and the NiCrB1055 powder have a grain size in a range of 60 μm to 70 μm.

9. The composite powder of claim 1, wherein both the Astroloy powder and the NiCrB1055 powder have a grain size of about 63 μm.

10. The composite powder of claim 2, wherein both the Astroloy powder and the NiCrB1055 powder have a grain size of about 63 μm.

11. The method of claim 7, wherein the superalloy part comprises nickel and is fitted on a nozzle sector of the turbine engine.

12. A method of diffusion-brazing assembly or resurfacing comprising contacting the composite powder of claim 2 with at least one superalloy part.

13. The method of claim 12, wherein the superalloy part comprises nickel.

14. The method of claim 12, further comprising heating the composite powder to a temperature in a range of 1180° C. to 1200° C. for a period in a range of 5 min to 30 min.

15. The method of claim 12, wherein the superalloy part is an element of a turbine engine.

16. A method of diffusion-brazing assembly or resurfacing comprising contacting the composite powder of claim 3 with at least one superalloy part.

17. The method of claim 16, wherein the superalloy part comprises nickel.

18. The method of claim 16, further comprising heating the composite powder to a temperature in a range of 1180° C. to 1200° C. for a period in a range of 5 min to 30 min.

19. The method of claim 16, wherein the superalloy part is an element of a turbine engine.

20. A method of diffusion-brazing assembly or resurfacing comprising contacting the composite powder of claim 8 with at least one superalloy part.
